(19) United States
(12) Patent Application Publication
(10) Pub. No.: US 2018/0050501 A1
(43) Pub. Date: Feb. 22, 2018

(54) Apparatus and Method to Authenticate 3D Printer Consumables

(71) Applicants: Vitaly Talyansky, Portland, OR (US); Edward Talyansky, Battle Ground, WA (US); Jose Gasque, Vancouver, WA (US); Justin Foster, Vancouver, WA (US)

(72) Inventors: Vitaly Talyansky, Portland, OR (US); Edward Talyansky, Battle Ground, WA (US); Jose Gasque, Vancouver, WA (US); Justin Foster, Vancouver, WA (US)

(21) Appl. No.: 15/241,727

(22) Filed: Aug. 19, 2016

(51) Int. Cl. B29C 67/00; B33Y 10/00; B33Y 30/00; B33Y 50/02; B33Y 70/00

(52) U.S. Cl. CPC B29C 67/0088; B29C 67/0055; B29C 67/0074; B29C 67/0092; B29K 2105/16; B33Y 30/00; B33Y 50/02; B33Y 70/00; B33Y 10/00

(57) ABSTRACT

Apparatus and method to authenticate 3D printer consumables are described herein. An example 3D printer includes a consumable used by the three-dimensional printer to print a three-dimensional object, the consumable containing embedded ceramic particles, the ceramic particles having luminescent properties such that they emit light having a first wavelength when they are illuminated by light having a second wavelength, and a detector to detect the presence of the ceramic particles in the consumable.

### FIELD OF THE DISCLOSURE

The present disclosure relates generally to identification and authentication of consumables and, more particularly, to an apparatus and method to authenticate 3D printer consumables.

### BACKGROUND

Many types of 3D printers use a filament or other material as a consumable to print three-dimensional objects. A 3D printer that can identify markers in a particular filament or other consumable has many advantages over traditional 3D printers and filament.

### BRIEF DESCRIPTION OF THE DRAWINGS

FIG. 1 is a block diagram of a 3D printer in accordance with the teachings of this disclosure.

FIG. 2 is a block diagram of a detector in accordance with the teachings of this disclosure.

FIG. 3 is a block diagram of an example extrusion head in accordance with the teachings of this disclosure.

FIG. 4 is a flowchart representative of example machine readable instructions that may be executed to implement the example 3D printer of FIG. 1.

FIG. 5 is a flowchart representative of example machine readable instructions that may be executed to implement the example 3D printer of FIG. 1 in conjunction with the extrusion head of FIG. 3.

FIG. 6 is a block diagram of an example processing system capable of executing the example machine readable instructions of FIGS. 4 and 5 to implement the example 3D printer of FIG. 1, the example detector of FIG. 2 and the example extrusion head of FIG. 3.

### DETAILED DESCRIPTION

Three-dimensional (3D) printers are capable of printing three-dimensional objects. These 3D objects can be used in a variety of commercial and/or non-commercial applications including rapid prototyping, end-use products, and collectibles among others. A wide variety of 3D printing technologies are available, each using a different type of consumable to create a three-dimensional printed object. It would be advantageous for a 3D printer to be able to recognize the type of consumable being used and to adjust the printer settings accordingly. Using improper settings for a particular consumable may cause a 3D printer to not print an object properly and could even damage the printer itself.

In addition, many manufacturers of 3D printers also sell consumables and the sale of these consumables represents a large portion of their income. If competitors are able to sell generic consumables that can be used with these 3D printers, the manufacturers of the 3D printers may lose this valuable source of income. In addition, an off-brand consumable might not work as well with a 3D printer and may even damage the printer. This can potentially lead to false warranty claims made by a consumer against the 3D printer manufacturer that should not be valid because an inappropriate consumable was used with the printer. As such, it is desirable for 3D printers to recognize generic consumables and only allow consumables provided by the manufacturer of the 3D printer or other authorized parties to be used with the printer.

Another object of the present invention is to allow a 3D printer to mark an object while it is being printed so that the object can later be identified as being printed by a specific printer. This can be done for a variety of reasons including security purposes or to allow items to be printed as collectibles. Another object of the present invention is to allow a 3D printer to mark certain areas of a 3D printed object. This allows for additional security on the object being printed as well as allowing for an artistic signature to be added to the object such that a user of a 3D printer can mark an object in a manner that no other user will.

The present invention can be used with consumables for a variety of 3D printer technologies including thermoplastic, photopolymer, powder and laminated technologies. One type of 3D printer technology is fused deposition modeling (FDM). In FDM, the consumable is a thermoplastic filament that is heated to its melting point and extruded through a nozzle. The object is built in additive layers using the filament material. The nozzle moves horizontally in two dimensions to extrude the filament in the proper locations based on the design of the object being printed. As the filament is extruded, it cools and hardens. After one layer is completed, the next layer is printed and so on until the entire object is printed. The printer may also have a separate nozzle for extruding support material to support upper layers of the object during printing. After printing the object, the support material can be dissolved or removed from the object.

There are a variety of different types of filament that can be used with 3D printers. Two of the most popular are polyactic acid (PLA) and acrylonitrile butadiene styrene (ABS) filaments. PLA, ABS and other types of filaments have different properties that are better suited for different types of printing projects. However, these different types of filaments often have different melting temperatures or other parameters that must be accounted for by the 3D printer. If a 3D printer does not appropriately adjust its settings to account for the type of filament being used, the object being printed will not print properly and the printer itself may be damaged. It is an object of the present invention to mark different types of filaments with an invisible marker that can be detected by a 3D printer that automatically adjusts its settings to account for the type of filament being used.

Example methods, apparatus, and/or articles of manufacture disclosed herein provide for authentication of 3D printer filament. In examples disclosed herein, filament for FDM 3D printers is marked by embedding ceramic, luminescent phosphors in the filament. In examples disclosed herein, a 3D printer contains a detector that detects the presence of the phosphors in the filament and only allows printing with the filament if the phosphors are present. In some examples disclosed herein, the 3D printer detects the presence of phosphors in a filament and adjusts the settings of the printer based on the detected phosphor. In other examples disclosed herein, a 3D printer mixes phosphor with filament as an object is being printed in order to mark the object with the phosphor.

Another type of 3D printer technology is photopolymer technology including stereolithography and digital light processing (DLP). In these types of 3D printer technologies, the consumable is a liquid plastic that hardens when exposed to a laser or other light source. In these 3D printers, an object is built in layers by exposing a liquid plastic to a light source at the appropriate locations according to the design of the object to be printed. Once the liquid plastic hardens, the printer does the same thing for the next layer and continues this process until all the layers of the object are complete.

Example methods, apparatus, and/or articles of manufacture disclosed herein provide for authentication of photopolymer consumables for 3D printers. In examples disclosed herein, photopolymers for stereolithography or DLP 3D printers are marked by embedding ceramic, luminescent phosphors in the photopolymer. In examples disclosed herein, a 3D printer contains a detector that detects the presence of the phosphors in the photopolymer and only allows printing with the photopolymer if the phosphors are present. In some examples disclosed herein, the 3D printer detects the presence of phosphors in photopolymer and adjusts the settings of the printer based on the detected phosphor. In other examples disclosed herein, a 3D printer mixes phosphor with a photopolymer as an object is being printed in order to mark the object with the phosphor.

Another type of 3D printer technology is powder technology including selective laser sintering (SLS), selective laser melting (SLM), and electron beam melting (EBM). In these 3D printing technologies, the consumable is a powdered material that is fused together to form a printed object when exposed to a laser, in the case or SLS or SLM, or to an electron beam, in the case of EBM.

Example methods, apparatus, and/or articles of manufacture disclosed herein provide for authentication of powder consumables for 3D printers. In examples disclosed herein, powder consumables for 3D printers are marked by embedding ceramic, luminescent phosphors in the powder. In examples disclosed herein, a 3D printer contains a detector that detects the presence of the phosphors in the powder consumable and only allows printing with the powder if the phosphors are present. In some examples disclosed herein, the 3D printer detects the presence of phosphors in powder consumables and adjusts the settings of the printer based on the detected phosphor. In other examples disclosed herein, a 3D printer mixes phosphor with a powder as an object is being printed in order to mark the object with the phosphor.

Another type of 3D printer technology is laminated object manufacturing (LOM). In LOM 3D printers, layers of paper, plastic or metal laminates are fused together with heat and/or pressure and cut with a laser or blade into the appropriate shape of an object being printed.

Example methods, apparatus, and/or articles of manufacture disclosed herein provide for authentication of laminate consumables for LOM 3D printers. In examples disclosed herein, laminate consumables for LOM 3D printers are marked by embedding ceramic, luminescent phosphors in the laminate. In examples disclosed herein, a 3D printer contains a detector that detects the presence of the phosphors in the laminate consumable and only allows printing with the laminate if the phosphors are present. In some examples disclosed herein, the 3D printer detects the presence of phosphors in laminate consumable and adjusts the settings of the printer based on the detected phosphor. In other examples disclosed herein, a 3D printer mixes phosphor with a laminate consumable as an object is being printed in order to mark the object with the phosphor.

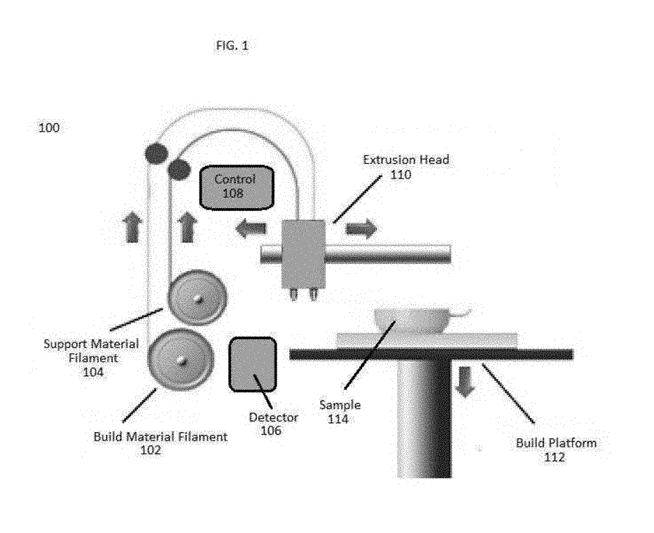

FIG. 1 is a block diagram of a 3D printer 100 in accordance with the teachings of this disclosure. In the illustrated example, the 3D printer 100 is a FDM type printer. In other examples, the 3D printer 100 may be one that uses any other type of 3D printing technology including stereolithography, digital light processing, selecting laser sintering, selective laser melting, electronic beam melting, or laminated object manufacturing, among others. The example 3D printer 100 of FIG. 1 includes a build material filament 102, a support material filament 104, a detector 106, a control 108, an extrusion head 110, a build platform 112 and a sample 114.

The example build material filament 102 of FIG. 1 is comprised of a traditional 3D printer filament that has been embedded with ceramic, luminescent phosphors called taggant. In some examples, the build material filament 102 is a PLA filament. In some examples, the build material filament 102 is ABS filament. In other examples, the build material filament 102 may be any other type of filament compatible with the 3D printer 100.

In the illustrated example, the build material filament 102 is a thermoplastic spool with a known melting temperature. During the printing process, the build material filament 102 is unspooled and passed through the extrusion head 110 where it is heated to its melting point. The melted build material filament 102 is then sprayed into appropriate locations by the example extrusion head 110 to form the shape of the example sample 114. The melted build material filament 102 then cools and hardens into the appropriate shape. In some examples, the 3D printer 100 contains multiple filaments comprised of different materials. This allows the 3D printer 100 to print the sample 114 with a combination of different materials.

In the illustrated example, taggant is embedded into the build material filament 102. Taggant consists of inorganic, ceramic particles that have the optical property of luminescence. Luminescence is the property of certain materials such that when they are illuminated by light at a particular wavelength (the excitation wavelength), they emit light at another wavelength (the emission wavelength). In the illustrated example, the taggant embedded into the build material filament 102 consists of inorganic, ceramic phosphors with a mean particle size of less than one micron in diameter. Accordingly, they do not interact with or change the properties of the example build material filament 102 and do not interfere with the normal operation of the example 3D printer 100. In examples where the 3D printer 100 contains multiple filaments, different taggants with different excitation and emission wavelengths are embedded in each of the filaments. This allows the identification of each type of filament material that is used to print the sample 114.

In the illustrated example, taggant is mixed with the build material filament 102 during the manufacture of the filament and is evenly dispersed throughout the build material filament 102. In some examples, taggant is embedded in the build material filament 102 after the filament is manufactured. In the illustrated example, taggant is embedded in the build material filament 102 such that the filament has the same optical luminescent properties as the taggant such that the build material filament 102 emits light at the taggant's emission wavelength when it is illuminated by light at the taggant's excitation wavelength.

The example support material filament 104 is a material used to temporarily build support structures while the example sample 114 is being printed by the example 3D printer 100. The example 3D printer 100 constructs the example sample 114 using an additive process by building each layer of the sample 114 from the bottom upwards. Therefore, for certain objects, certain portions of the example sample 114 may need to be supported until the entire sample 114 is printed. This is accomplished by using support structures which are produced from the example support material filament 104. In the illustrated example, the support material filament is a different material than the build material filament 102. In the illustrated example, after the sample 114 is finished being printed, any support structures made from the support material filament 104 can be broken off of the sample 114. In some examples, the support material filament 104 is dissolvable in a certain liquid such that after the sample 114 is finished printing, the sample 114 can be placed in this liquid and the support structures will dissolve. In the illustrated example, the support material filament 104 does not contain taggant.

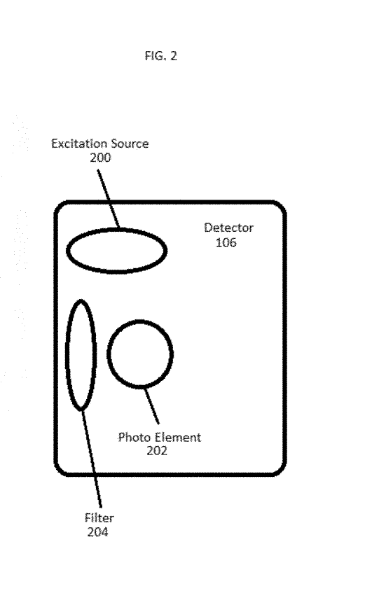

The example detector 106 detects the presence of taggant in the example build material filament 102. In the illustrated example, the detector 106 illuminates the build material filament 102 with light at the taggant's excitation wavelength and detects the emission of light at the taggant's emission wavelength by the build material filament 102. The example detector 106 is discussed in further detail below in connection with FIG. 2.

The example control 108 controls the operation of the example 3D printer 100. In the illustrated example, the control 108 holds data about the sample 114 and communicates with the extrusion head 110 in order for the extrusion head 110 to print the sample 114 in the appropriate shape. The example control 108 also communicates with the example detector 106 to control the operation of the detector 106. In some examples, the control 108 contains data about where on the sample 114 taggant should be placed. In some examples where the 3D printer 100 uses multiple filaments, the control 108 holds data about which filament to use for which portions of the sample 114.

The example extrusion head 110 prints the example sample 114. The example extrusion head 110 has two extrusion nozzles, one for extruding build material and one for extruding support material. In the illustrated example, the support material filament 104 and the build material filament 102 are unspooled and passed to the extrusion head 110. The example extrusion head 110 moves in two dimensions in order to extrude the build material and support material in the appropriate locations in order to print the example sample 114 in accordance to the design stored in the example control 108.

The example build platform 112 is the surface upon which the example sample 114 is printed. The example sample 114 is printed in layers starting with the bottom layer and then building subsequent layers in an additive process. After each layer of the example sample 114 is printed by the extrusion head 110, the build platform 112 lowers so that the extrusion head 110 can print the next layer.

The example sample 114 is the object that is printed by the example 3D printer 100. The shape of the example sample 114 is stored in the example control 108 along with the necessary instructions for printing it. The example sample 114 is printed using the example build material filament 102 which contains embedded taggant. Therefore, the example sample 114 will contain embedded taggant when it is completed.

FIG. 2 is a block diagram of the example detector 106 of FIG. 1. The example detector 106 includes an excitation source 200, a photo element 202 and a filter 204.

The example excitation source 200 emits light at the excitation wavelength of the taggant embedded in the example build material filament 102. In the illustrated example, the excitation source 200 is a light emitting diode. In other examples, the excitation source 200 may be a laser or any other device or component capable of emitting light at the appropriate wavelength. In the illustrated example, the excitation wavelength of the taggant in the build material filament 102 is in the infrared portion of the electromagnetic spectrum. In other examples, the excitation wavelength of the taggant in the build material filament 102 may be in any other portion of the electromagnetic spectrum.

The example photo element 202 detects light at the emission wavelength of the taggant in the example build material filament 102. In the illustrated example, the photo element 202 is a photodiode. In other examples, the photo element 202 may be any other device or component capable of detecting light at the appropriate wavelength. In the illustrated example, the emission wavelength of the taggant in the build material filament 102 is in the infrared portion of the electromagnetic spectrum. In other examples, the emission wavelength of the taggant in the build material filament 102 may be in any other portion of the electromagnetic spectrum.

The example filter 204 is an optical filter that blocks light at wavelengths other than the emission wavelength of the taggant embedded in the build material filament 102. This prevents light at other wavelengths from interfering with the example photodiode 202 and its detection of the taggant's luminescent emission.

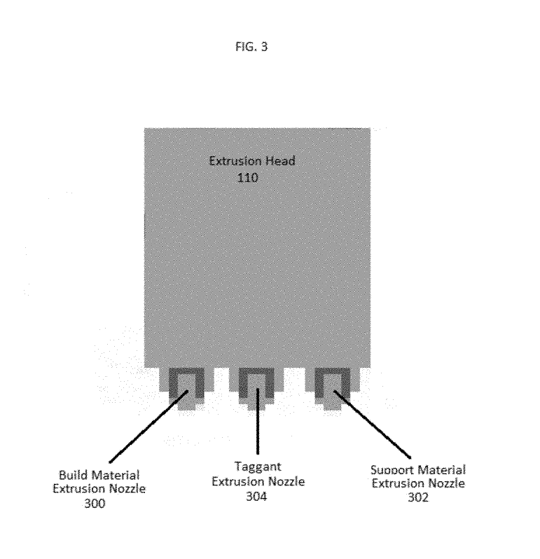

FIG. 3 is a block diagram of another example extrusion head 110 of FIG. 1. In the illustrated example of FIG. 3, the extrusion head 110 includes a build material extrusion nozzle 300, a support material extrusion nozzle 302 and a taggant extrusion nozzle 304. The example build material extrusion nozzle 300 extrudes build material to print the example sample 114 of FIG. 1. The example support material extrusion nozzle 302 extrudes support material to print support structures for the example sample 114 of FIG. 1. In the illustrated example of FIG. 3, the taggant extrusion nozzle 304 extrudes taggant while the sample 114 is being printed. In this example, the build material filament 102 does not contain taggant. Instead, taggant is extruded from the example taggant extrusion nozzle 304 simultaneously with build material being extruded from the example build material extrusion nozzle 300. In this manner, taggant becomes embedded in the example sample 114 while the sample 114 is being printed.

While an example manner of implementing the apparatus and method to authenticate 3D printer filament has been illustrated in FIG. 1, one or more of the elements, processes and/or devices illustrated in FIG. 1 may be combined, divided, re-arranged, omitted, eliminated and/or implemented in any other way. Further, the example detector 106, control 108 and/or, more generally, the example 3D printer 100 of FIG. 1 may be implemented by hardware, software, firmware and/or any combination of hardware, software and/or firmware. Thus, for example, any of the example detector 106, control 108 and/or, more generally, the example 3D printer 100 of FIG. 1 of FIG. 1 could be implemented by one or more circuit(s), programmable processor(s), application specific integrated circuit(s) (ASIC(s)), programmable logic device(s) (PLD(s)), microprocessor(s), hardware processor(s), and/or field programmable logic device(s) (FPLD(s)), etc. When any of the system or apparatus claims of this patent are read to cover a purely software and/or firmware implementation, at least one of the example detector 106, control 108 and/or, more generally, the example 3D printer 100 of FIG. 1 to authenticate documents of FIG. 1 is hereby expressly defined to include a tangible computer readable storage medium such as a memory, DVD, CD, Blu-ray, etc. storing the software and/or firmware. Further still, the example detector 106, control 108 and/or, more generally, the example 3D printer 100 of FIG. 1 may include more than one of any or all of the illustrated elements, processes and devices.

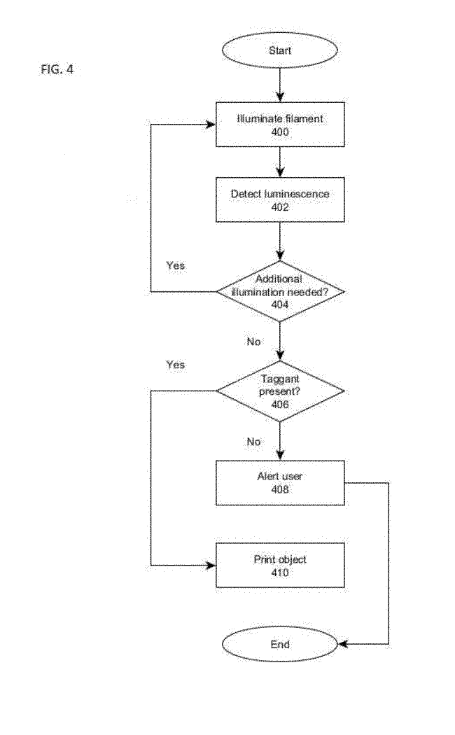

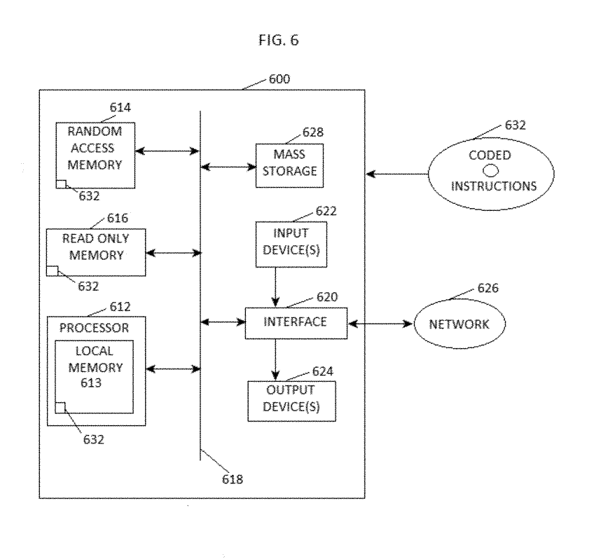

FIG. 4 is a flowchart representative of example machine readable instructions for implementing the example 3D printer 100 of FIG. 1. In the example flowchart of FIG. 4, the machine readable instructions comprise program(s) for execution by a processor such as the processor 612 shown in the example computer 600 discussed below in connection with FIG. 6. The program(s) may be embodied in software stored on a tangible computer readable storage medium such as a CD-ROM, a floppy disk, a flash drive, a hard drive, a digital versatile disk (DVD), a Blu-ray disk, or a memory associated with the processor 612, but the entire program and/or parts thereof could alternatively be executed by a device other than the processor 612 and/or embodied in firmware or dedicated hardware. Further, although the example program(s) is described with reference to the flowchart illustrated in FIG. 6, many other methods of implementing the example 3D printer 100 of FIG. 1 may alternatively be used. For example, the order of execution of the blocks may be changed, and/or some of the blocks described may be changed, eliminated, or combined.

As mentioned above, the example processes of FIG. 4 may be implemented using coded instructions (e.g., computer readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable storage medium is expressly defined to include any type of computer readable storage device and/or disk and to exclude propagating signals. Additionally or alternatively, the example processes of FIG. 4 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable storage medium is expressly defined to include any type of computer readable storage device and/or disk and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

In the example of FIG. 4, the detector 106 determines whether the build material filament 102 contains taggant and only prints the example sample 114 if taggant is detected. FIG. 4 begins when the example excitation source 200 of the example detector 106 illuminates the example build material filament 102 with light (block 400). In the illustrated example, the excitation source 200 illuminates the build material filament 102 for a particular length of time (e.g., 100 milliseconds). In other examples, the excitation source 200 may illuminate the build material filament 102 for variable amounts of time. In the illustrated example, if the build material filament 102 is authorized for use with the 3D printer 100, it contains taggant with known excitation and emission wavelengths. In the illustrated example, the excitation source 200 emits light at a wavelength equal to the excitation wavelength of the taggant. If the example build material filament 102 is authorized and contains taggant, the taggant will emit light at its emission wavelength when it is illuminated by light at its excitation wavelength. If the example build material filament 102 is not authorized and does not contain taggant, it will not emit luminescence when it is illuminated. In the illustrated example, the excitation source 200 illuminates the build material filament 102 with light at one particular wavelength. In other examples, the excitation source 200 illuminates the build material filament 102 with light at multiple wavelengths in a particular sequence. This allows for the detection of multiple types of taggants.

After the example excitation source 200 of the example detector 106 illuminates the example build material filament 102 with light (block 400), the example photo element 202 of the example detector 106 detects light emitted by the example build material filament 102 (block 402). Any luminescent emission by the build material filament 102 will pass through the example filter 204 and illuminate the example photo element 202. If the example build material filament 102 contains taggant, it will emit light at the emission wavelength of the taggant. Light at this wavelength will pass through the example filter 204 and be detected by the example photo element 202, which is sensitive to light at this wavelength. The example photo element 202 determines the strength of the luminescent signal emitted by the example build material filament 102.

After the example photo element 202 detects the light emitted by the example build material filament 102 (block 402), the example control 108 determines whether additional the example build material filament 102 should be illuminated additional times (block 404). In the illustrated example, the excitation source 200 illuminates the build material filament a predetermined number of times and the photo element 202 measures the luminescent response after each such illumination. In some examples, the excitation source 200 illuminates the build material filament once. In other examples, the number of times that the excitation source 200 illuminates the build material filament 102 depends on the luminescent response measured by the photo element 202. If the example control 108 determines that additional illuminations are needed, control returns to block 400. If the example control 108 determines that additional illuminations are not needed, control advances to block 406.

After the example control 108 determines that additional illuminations are not needed (block 404), the control 108 determines whether taggant is present in the example build material filament 102 (block 406). In the illustrated example, the control 108 determines that taggant is present if the luminescence detected by the photo element 202 is above a threshold. In other examples, other methods of determining whether taggant is present in the example build material filament 102 may be based on the luminescence detected by the photo element 202. In some examples, the control 108 also determines the type of taggant detected based on the luminescence detected in block 402. If the example control 108 determines that taggant is present, control passes to block 410. If the example control 108 determines that taggant is not present, control passes to block 408.

After the example control 108 determines that taggant is not present in the build material filament 102 (block 406), the control 108 alerts the user that the build material filament 102 is not authorized to be used with the printer (block 408). In the illustrated example, the user is alerted through a visual display. In other examples, an audio alert or other methods of alerting the user may be used. When the example control 108 determines that the example build material filament 102 does not contain taggant and is not authorized to be used to print, the example 3D printer 100 will not allow the example sample 114 to be printed with the un-authorized build material filament 102. Therefore, the example of FIG. 4 ends at this point.

After the example control 108 determines that taggant is present in the example build material filament 102 (block 406), the example 3D printer 100 prints the example sample 114 via its normal operation (block 410). This ensures that authorized filament prints normally. In some examples, the 3D printer 100 prints the example sample 114 after the control 108 adjusts the settings of the 3D printer 100 based on the taggant detected in block 406. The example of FIG. 4 then ends.

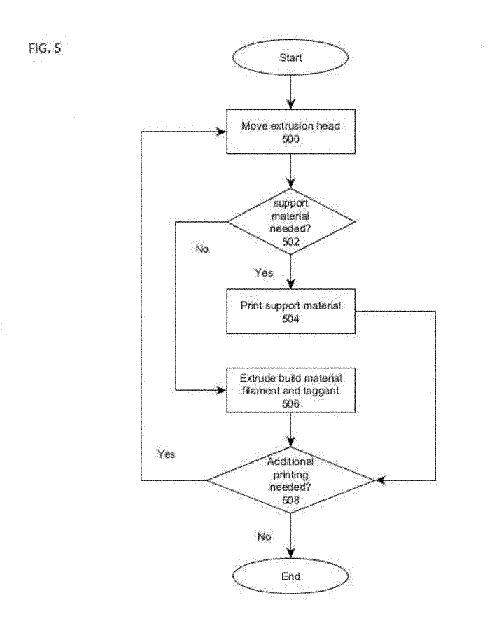

FIG. 5 is a flowchart representative of example machine readable instructions for implementing the example 3D printer 100 in combination with the example extrusion head 110 of FIG. 3. In the example of FIG. 5, the extrusion head 110 of FIG. 3 is used in the 3D printer 100 to mix taggant with filament while an object is being printed. This allows an object to be later identified as being printed by a specific 3D printer.

The example of FIG. 5 begins when the extrusion head 110 is moved into position to begin printing the sample 114 (block 500). The position in which to move the example extrusion head 110 is determined by the design for the particular shape of the example sample 114 stored in the example control 108.

After the example extrusion head 110 moves to its initial position to begin printing the example sample 114 (block 500), the example control 108 determines whether support material or build material is needed at this location based on the design for the sample 114 stored in the control 108 (block 502). If support material is needed, control passes to block 504. If support material is not needed, control passes to block 506.

After the example control 108 determines that support material is needed at the current position of the example extrusion head 110 (block 502), the example support material extrusion nozzle 302 extrudes a portion of the example support material filament 104 (block 504). After the example support material filament 104 is extruded, it will eventually dry and harden into the support structure needed to print the example sample 114. Control then passes to block 508.

After the example control 108 determines that support material is not needed at the current position of the example extrusion head 110 (block 502), the example build material extrusion nozzle 302 emits a portion of the example build material filament 102 and the example taggant extrusion nozzle 304 simultaneously extrudes a small amount of taggant (block 506). The example build material filament 102 will eventually harden around and dry around the extruded taggant to become the example sample 114, which will subsequently contain taggant itself. The example sample 114 can later be identified as having been printed by the specific example 3D printer 100 by detecting the presence of the embedded taggant. Control then passes to block 508.

After the example extrusion head 110 extrudes support material filament (block 504) or build material filament and taggant (block 506), the example control 108 determines whether additional printing is needed (block 508). If the example sample 114 has not been completely printed, then the example control 108 determines that additional printing is needed and control returns to block 500 and the example extrusion head 110 is moved to the next location required to continue the printing of the sample 114. If the example sample 114 is completely printed, then the example control 108 determines that no additional printing is needed and the example of FIG. 5 ends.

FIG. 6 is a block diagram of a processor platform 600 capable of executing the instructions of FIGS. 4-5 to implement the example 3D printer of FIG. 1. The processor platform 600 can be, for example, a server, a personal computer, an Internet appliance, a DVD player, a CD player, a Blu-ray player, a gaming console, a personal video recorder, a smart phone, a tablet, a printer, or any other type of computing device.

The processor platform 600 of the instant example includes a processor 612. As used herein, the term “processor” refers to a logic circuit capable of executing machine readable instructions. For example, the processor 612 can be implemented by one or more microprocessors or controllers from any desired family or manufacturer.

The processor 612 includes a local memory 613 (e.g., a cache) and is in communication with a main memory including a volatile memory 614 and a non-volatile memory 616 via a bus 618. The volatile memory 614 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 616 may be implemented by flash memory and/or any other desired type of memory device. Access to the main memory 614, 616 is controlled by a memory controller.

The processor platform 600 also includes an interface circuit 620. The interface circuit 620 may be implemented by any type of interface standard, such as an Ethernet interface, a universal serial bus (USB), and/or a PCI express interface.

One or more input devices 622 are connected to the interface circuit 620. The input device(s) 622 permit a user to enter data and commands into the processor 612. The input device(s) can be implemented by, for example, a keyboard, a mouse, a touchscreen, a track-pad, a trackball, isopoint and/or a voice recognition system.

One or more output devices 624 are also connected to the interface circuit 620. The output devices 624 can be implemented, for example, by display devices (e.g., a liquid crystal display, a cathode ray tube display (CRT), a printer and/or speakers). The interface circuit 620, thus, typically includes a graphics driver card.

The interface circuit 620 also includes a communication device such as a modem or network interface card to facilitate exchange of data with external computers via a network 626 (e.g., an Ethernet connection, a digital subscriber line (DSL), a telephone line, coaxial cable, a cellular telephone system, etc.).

The processor platform 600 also includes one or more mass storage devices 628 for storing software and data. Examples of such mass storage devices 628 include floppy disk drives, hard drive disks, compact disk drives and digital versatile disk (DVD) drives.

The coded instructions 632 of FIG. 6 may be stored in the mass storage device 628, in the volatile memory 614, in the non-volatile memory 616, and/or on a removable storage medium such as a CD or DVD.

Although certain example apparatus, methods, and articles of manufacture have been disclosed herein, the scope of coverage of this patent is not limited thereto. On the contrary, this patent covers all apparatus, methods, and articles of manufacture fairly falling within the scope of the claims of this patent.

What is claimed is:

1. A three-dimensional printer comprising:
a consumable used by the three-dimensional printer to print a three-dimensional object, the consumable containing embedded ceramic particles, the ceramic particles having luminescent properties such that they emit light having a first wavelength when they are illuminated by light having a second wavelength; and
a detector to detect the presence of the ceramic particles in the consumable.

2. The three-dimensional printer of claim 1, wherein the three-dimensional printer does not print the three-dimensional object if the detector does not detect the presence of the ceramic particles.

3. The three-dimensional printer of claim 1, further comprising a control that adjusts a setting of the printer based on the ceramic particles detected by the detector.

4. The three-dimensional printer of claim 1, wherein the consumable is a photopolymer.

5. The three-dimensional printer of claim 1, wherein the consumable is a powder.

6. The three-dimensional printer of claim 1, wherein the consumable is a laminate.

7. The three-dimensional printer of claim 1, wherein the consumable is a thermoplastic build material filament.

8. The three-dimensional printer of claim 1, wherein the detector comprises an excitation source to emit light at the second wavelength and a photo element to detect light at the first wavelength.

9. The three-dimensional printer of claim 1, wherein the consumable is a build material filament, the three-dimensional printer further comprising an extrusion head to receive the build material filament and extrude the build material filament in a first pattern, wherein the extrusion head does not extrude the build material filament if the detector does not detect the presence of the ceramic particles.

10. The three-dimensional printer of claim 1, wherein the first wavelength and the second wavelength are in the infrared portion of the electromagnetic spectrum.

11. The three-dimensional printer of claim 1, wherein the ceramic particles have a mean diameter of less than one micron.

12. The three-dimensional printer of claim 1, further comprising an optical filter that passes light with a narrow band of wavelengths around the first wavelength and blocks light at other wavelengths.

13. A method comprising:
illuminating a first build material filament in a three-dimensional printer with a first light at a first wavelength;
detecting a first strength of a second light at a second wavelength emitted by the first build material filament after the first build material filament is illuminated by the first light; and
adjusting a setting of the three-dimensional printer based on the first strength.

14. The method of claim 13, further comprising:
illuminating a second build material filament in the three-dimensional printer with a third light at a third wavelength;
detecting a second strength of a fourth light at a fourth wavelength emitted by the second build material filament after the second build material filament is illuminated by the third light; and
adjusting a setting of the three-dimensional printer based on the first strength and the second strength.

15. The method of claim 13, further comprising:
extruding the build material filament through an extrusion head to print a three-dimensional object if the first strength is above a first threshold.

16. A three-dimensional printer comprising:
build material filament having a first material composition that is used by the three-dimensional printer to print a three-dimensional object;
an extrusion head to receive the build material filament;
a build material extrusion nozzle affixed to the extrusion head to extrude the build material filament in a first pattern to print a three-dimensional object;
a taggant extrusion nozzle affixed to the extrusion head to extrude first ceramic particles having luminescent properties such that the first ceramic particles emit light at a first wavelength when they are illuminated by light at a second wavelength, wherein the taggant extrusion nozzle extrudes the first ceramic particles simultaneous to the extrusion of build material filament by the build material extrusion nozzle such that the first ceramic particles become embedded in the three-dimensional object as the three-dimensional object is being printed by the three-dimensional printer.

17. The three-dimensional printer of claim 16, further comprising:
support material filament having a second material composition different from the first material composition;
a support material extrusion nozzle connected to the extrusion head to extrude the support material filament in a second pattern to provide support for the three-dimensional object while it is being printed.

18. The three-dimensional printer of claim 16, wherein the taggant extrusion nozzle extrudes the first ceramic particles simultaneous to a first set of time intervals when the build material extrusion nozzle extrudes build material filament and the taggant extrusion nozzle does not extrude the first ceramic particles during a second set of time intervals when the build material extrusion nozzle extrudes build material filament such that taggant becomes embedded in a portion of the three-dimensional object as the three-dimensional object is being printed by the three-dimensional printer.

19. The three-dimensional printer of claim 16, wherein the first wavelength and the second wavelength are in the infrared portion of the electromagnetic spectrum.

20. The three-dimensional printer of claim 16, wherein the first ceramic particles have a mean diameter of less than one micron.
